(19) United States
(12) Patent Application Publication
(10) Pub. No.: US 2012/0256447 A1
(43) Pub. Date: Oct. 11, 2012

(54) WINDOW UNIT FOR WINDOWS IN MOTOR VEHICLES

(76) Inventor: Joachim Majer, Neckarsulm (DE)

(21) Appl. No.: 13/440,274

(22) Filed: Apr. 5, 2012

(30) Foreign Application Priority Data
Apr. 6, 2011 (DE) 20 2011 000 804.5

(51) Int. Cl. B60J 1/00

(52) U.S. Cl. 296/201

(57) ABSTRACT

A window unit in which a primary part is moulded onto an edge region of a window on one, two or three sides, and a secondary part at least partially encompasses the primary part and rests directly on the window on the outside of the window and is fixed to the window by means of a primer or bonding agent.

This application claims priority to German Patent Application No. 20 2011 000 804.5 filed Apr. 6, 2011, which is hereby incorporated herein by reference.

### FIELD

The invention relates to a window unit for windows in motor vehicles and the like, having a window with a frame which has a frame profile and encompasses the edge of the window on at least two peripheral sides, wherein the frame grips the window or encompasses the window on at least two peripheral sides in the form of a ring which is enclosed in itself, and the frame is formed from two profile parts having a primary part and a secondary part, and the primary part is in the form of a hard component, the dimensional stability of which is greater than that of the secondary part which is in the form of a soft component.

### BACKGROUND

Such window units with 2-component overmoulding have been known for a long time. To manufacture a frame which runs around the window, a primer or adhesive is applied in the edge region of the window on an inner side, a face side and an outer side before a primary part in the form of a hard component is moulded onto the edge region of the peripheral side of the window. A secondary part in the form of a soft component is then moulded onto this hard component, wherein this secondary part does not rest on the window but partially encompasses the primary part. In doing so, it is particularly important to apply the primer or bonding agent accurately on the outer side of the window so that, after attaching the moulding, the primer or bonding agent is not visible due to a protrusion. However, the problem usually occurs with overmoulding that the primer protrudes due to tolerances. This constitutes a visual impairment and requires manual rework in order to remove the applied primer or bonding agent from the outside of the window.

A window unit for windows of motor vehicles and the like, in which a window with a plastic frame which has a certain cross-sectional profile is provided, is disclosed in EP 0857116 B1. This window unit is inserted into a pre-determined opening of the motor vehicle and fixed therein with the help of its frame. The frame is formed from two profile parts, of which the primary profile part encompasses the edge region of the glass window on three sides with positive locking. The frame is made by injection moulding a plastic for the primary profile part around the window. A secondary profile part with further profile sections is then applied to the primary part, thus resulting in a 2-component overmoulding of the window. The secondary part has lower dimensional stability of its material than the primary part and is sufficiently flexible to form soft sealing strips. This window arrangement has been developed particularly in order to be able to dispense with the primer used in the previously mentioned prior art. At the same time, an adequate sealing effect is produced with the softer secondary part without the need to introduce a primer between the window and the primary part. This window arrangement has been well proven on vehicles fitted therewith. When manufacturing this window unit, sealing tests, which are time-consuming and cost-intensive, are necessary in order to guarantee the sealing in different applications of the vehicle. These tests include a so-called Kärcher test to test the sealing against spray water, and a water column test to test the sealing of a vertical water column on the outside of the window arrangement.

### SUMMARY

The invention provides a window unit with which the sealing is guaranteed, but elaborate tests during manufacture can be avoided, and yet a frame can be manufactured with little effort.

More particularly, the present invention provides a window unit in which a primary part is moulded onto an edge region of a window on one, two or three sides, and a secondary part at least partially encompasses the primary part and rests directly on the window on the outside of the window and is fixed to the window by means of a primer or bonding agent. On the one hand, a window unit may have the advantage that all that is necessary to achieve a watertight arrangement is a complete wetting of the edge region with primer or bonding agent on the outside of the window. It is sufficient to apply a primer or bonding agent to only an outer side of the window in the edge region to stick the secondary part to the window and produce the water tightness. This enables the required tests, such as the Kärcher test or the water column test for example, to be dispensed with. In addition, this arrangement enables the further regions of the primary part and secondary part which encompass the edge region of the window to be flexible in design and adapted to suit different requirements.

An advantageous embodiment of the invention is provided in that the secondary part at least partially encompasses the primary part on the inside of the window. Although it is adequate for the water tightness that the secondary part is securely bonded to the outside of the window with primer or bonding agent, this embodiment has improved noise attenuation of road noise. In addition, this can ensure that the more elastic secondary part, which at least partially encompasses the primary part, exerts a certain force on the primary part, as a result of which the primary part is additionally pressed against the window and a primer or bonding agent is unnecessary.

In addition, it is preferably provided that the secondary part encompasses or covers the primary part on the inside of the window but does not rest on the inside of the window or is arranged at a distance from the inside of the window. At the same time, it is preferably provided that the secondary part extends preferably to an equal or very similar extent on the outside and the inside of the window from a face side of the window to the centre of the window so that effectively two legs which run parallel to one another are formed, and, as long as the primary part is provided there, the primary part is formed on the inside opposite the secondary part projecting towards the centre of the window. With this embodiment, in particular an additional clamping effect or holding effect of the secondary part can be exerted on the primary part regardless of whether this extends and is formed on the edge region of the window only on the inside, the face side or partly on the outside or in any combination thereof.

An alternative embodiment of the invention provides that the secondary part covers the primary part on the inside of the window and rests directly against the window. In special cases, this embodiment can be chosen to achieve a desired visual appearance. This embodiment can also be of advantage when the primary part is fixed to the inside of the window by means of a primer, and the primer application or bonding agent application protrudes beyond the primary part so that the secondary part, which subsequently extends over it, covers this protrusion such that no primer or bonding agent is visible on the inside either, and has an appropriate visual appearance.

Furthermore, it is preferably provided that the secondary part which rests on the inside of the window is at least partially fixed to the window by means of a primer or bonding agent. This arrangement is chosen particularly when the primary part, which is entirely enclosed by the secondary part, is not attached to the edge region of the window by means of a primer or bonding agent. However, this does not rule out that in some cases the primary part is also fixed to the window by means of a primer or bonding agent.

A further preferred embodiment of the invention provides that the application width of the primer or bonding agent in the edge region of the window on an outer side of the window compared with the secondary part which covers the edge region on the outside is such that the primer or bonding agent has an undercut with respect to the edge termination of the secondary part which projects towards the centre of the window. An undercut exists when the primer or bonding agent does not reach as far as the outer edge termination of the secondary part and the edge termination of the secondary part which faces the centre of the window is therefore exposed. As a result, the primer is visually undetectable from the outside so that the window unit is characterised exclusively by the visual effect of the secondary part. The application of a narrow strip of primer or bonding agent can preferably be carried out at the usual activation temperature for primers of 80° C. to 120° C. However, due to the small amount required, only a little thermal energy is transferred to the window with the heated primer or bonding agent. The window is therefore only heated to a small depth and only to a small extent, so that laminated glass panes, the laminated film of which would be damaged at too great a temperature, can also be used for the window arrangement according to the invention.

A further preferred embodiment has an application width of the primer or bonding agent in the edge region of the window on an inner side of the window which, compared with the primary part covering the edge region on the inside, is such that the primer or bonding agent is applied flush or with a protrusion relative to the primary part. A protrusion exists when the primary part rests entirely on the primer or bonding agent and this protrudes over the edge of the primary part and/or the bonding agent has a somewhat greater application width than would be necessary for fixing the edge. Furthermore, as an alternative, it can be provided that the secondary part projects beyond the primary part on the inside and is fixed to the protruding application of primer or bonding agent. In this case, the secondary part can bond with primer both on the inside and on the outside of the window. The primary part, which is enclosed by the secondary part, can only rest on the edge region of the window or be fixed by a primer or bonding agent. In doing so, heat is preferentially absorbed by the material of the primer in the region of the protrusion, for example when hot air is applied, whereby said protrusion releases more easily from the window. Furthermore, the heat is quickly conducted from this already released protrusion to the region between the window and the secondary part, so that this region can likewise be released from the window. When the secondary part has been released on the inside, the further steps can be carried out to separate the outside of the secondary part from the outside of the window or the primary part from the window. This enables recycling to be carried out more easily.

A further preferred embodiment provides that the primary part rests directly on or grips the window on the inside, on the face side or on the outside of the window or in a combination thereof, collectively or separately. With this embodiment, it is provided that a primer or bonding agent is used to provide an adhesive connection with the window exclusively for the secondary region which is formed on the outside of the window.

Alternatively, it can be provided that the primary part is fixed to the window by means of primer or bonding agent on the inside, on the face side or on the outside of the window or in any combination thereof, collectively or separately. Depending on the choice of materials or the conditions of use, it may also be necessary to fix the primary part to the window by means of a primer or bonding agent.

Furthermore, it is preferably provided that a seal, which, in order to fit the secondary part, seals a cavity in the injection moulding tool so that the secondary part does not completely encompass and cover the primary part, is formed on the primary part. Such a seal enables the contact pressures of the injection moulding tool to be made smaller while still enabling a clean edge termination of the secondary part with respect to the primary part to be achieved. As a result of this, smaller pressures are also transmitted to the window by the injection moulding tool, thus reducing the risk of breakage.

A further preferred embodiment of the invention provides that the seal is in the form of a peripheral elevation or hump. This enables a uniform surface pressure to be achieved when closing the injection moulding tool in order to close the cavity for fitting the secondary part.

Preferably, the seal is provided on the inside of the primary part. On the one hand, this enables the peripheral clamping effect of the secondary part to be maintained and, furthermore, enables such a seal to be attached to the primary part in the non-visible region of the window unit.

It has been shown to be advantageous that the protrusion and/or undercut lies in the range between 0.5 and 1.5 mm, preferably in the region of 1.0 mm.

The invention and further advantageous embodiments and improvements thereof are described and explained in more detail in the following with reference to the examples shown in the drawings. According to the invention, the characteristics to be found in the description and the drawings can be applied individually in their own right or jointly in any combination.

### BRIEF DESCRIPTION OF THE DRAWINGS

In the drawings:

FIG. 1 shows a window unit in side view on the outside of the vehicle with a 2-component overmoulding,

FIG. 2 shows a cross-sectional view through section I-I of the window unit according to FIG. 1 with a secondary part which is fixed to the outside by means of primer, and

FIG. 3 shows a cross-sectional view of an alternative embodiment to FIG. 2 with a secondary part which is fixed to the inside and outside by means of primer and which has undercutting and protrusion of the primer.

### DETAILED DESCRIPTION

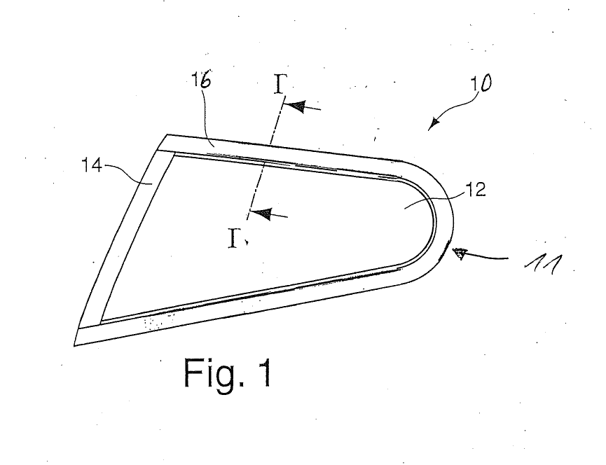

A window unit 10, which has a window 12, for example made of a glass, in particular silicate glass, or made of plastic, in particular synthetic resin or polycarbonate, is shown schematically in FIG. 1. Provided on the window 12 is a frame 11 which, according to the exemplary embodiment, encompasses the window 12 in the form of a ring. In the exemplary embodiment, it runs completely around the triangular window 12. Alternatively, it can be provided that the 2-component overmoulding 16 does not fully encompass the window 12, i.e. is not designed to run all the way round, but only encompasses individual side sections or only extends along individual face sides 13. Such a window unit 10 is fitted in the region of a specified opening of a body part, which is not shown in more detail, using already disclosed techniques and preferably permanently bonded to the body part. This window unit 10 can also be part of a constructional unit which is fitted in a door or in some other body part. For example, the window unit 10 can also have a window guide bar which, on one side, abuts the fixed window 12 and on the opposite side guides a window which can be moved up and down. In the exemplary embodiment, a bezel or decorative strip 14 is clipped or glued to a vertical section of the frame 11 for example. This can also be provided to run completely around an outer side of the frame 11.

The frame 11 has a frame profile and encompasses the edge region of the window 12 on one, two or three sides as an inner side 31, a face side 13 and/or an outer side 32. In doing so, the frame 11 grips the outside 32, the face side 13 and the inside 31 of the window 12 with its frame profile which is made of a 2-component or multi-component overmoulding. Alternatively, it can also be provided that the frame 11 only encompasses the window 12 with its frame profile on two sides, wherein a section of the frame profile rests on and is fixed to the outside 32 in each case.

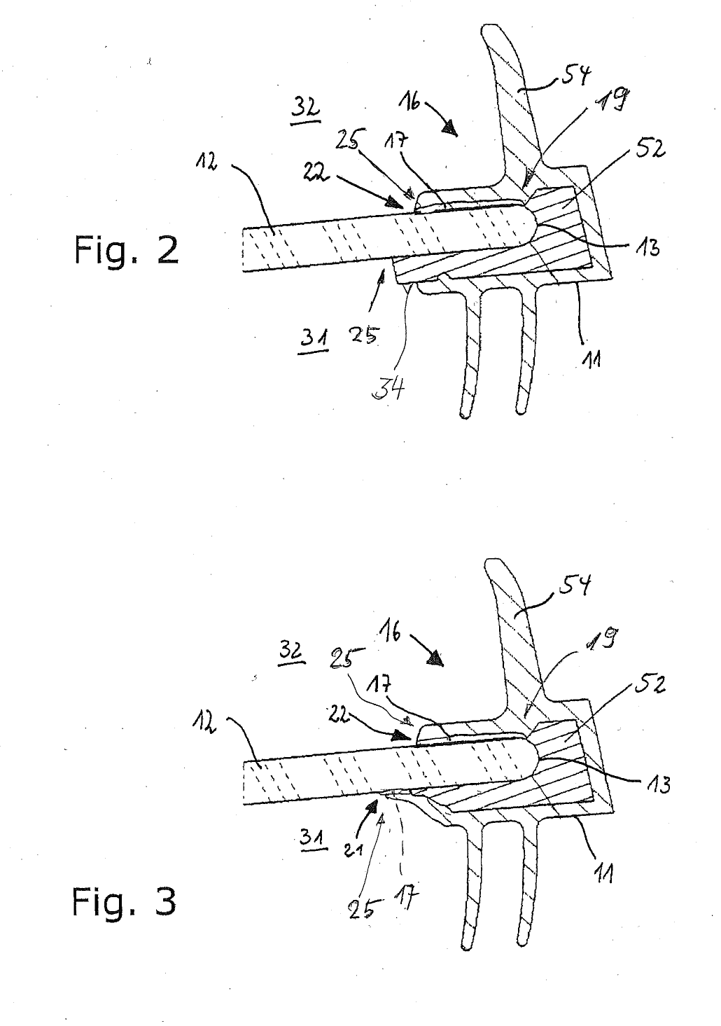

In the exemplary embodiment, the primary part 52 is designed in such a way that it rests on an inner side 31 and the face side 13. Alternatively, it can be provided that this primary part 52 rests on the window 12 only on the inside 31, only on the face side or only on the outside after a region which borders the face side 13 or in a combination thereof, collectively or separately. The secondary part 54 encompasses the primary part 52 in such a way that, in each case, a section of the secondary part 54 which faces the centre of the window rests directly on an outer side 32 of the window 12 and is fixed thereto by means of a primer 17 or bonding agent. Furthermore, the secondary part 54 extends at least in sections around the primary part 52 and preferably also extends at least partially on the inside 31 of the window 12, wherein, according to the exemplary embodiment in FIG. 2, the primary part 52 on the inside 31 is not completely covered but in fact a free edge termination 25 of the primary part 52 protrudes with respect to the secondary part 54. In this exemplary embodiment, it is provided that the primary part 52 is moulded directly onto the window 12. The secondary part 54 is then filled in a remaining cavity of the injection mould with the material for the secondary part 54 so that, on the one hand, the secondary part 54 rests on the outside 32 of the window 12 and, on the other, is joined to the primary part 52 or is welded thereto to a certain extent.

In order to produce such an overmoulding, a primer 17 can be applied to an outer side 32 of the window 12 before the primary part 52 is overmoulded, wherein the width of the primer application preferably corresponds to the width of the secondary part 54 which rests on the outside 32 of the window 12. In this embodiment, the primary part 52 is moulded onto the window 12 without primer 17. Due to the bonding of the secondary part 52 with the section resting on the outside 32 of the window 12, a complete seal of the overmoulding from the outside 32 to the inside 31 of the window 12 is achieved. The at least partial overmoulding of the primary part 52 by the secondary part 54 enables the primary part 52 to be fixed to the window 12, thus also resulting in a fixed arrangement of the overmoulding in the face region and on the inside 31 of the window 12.

A further preferred embodiment provides that the application width of the primer 17 on the outside 32 of the window 12 is such that, after overmoulding the secondary part 54, the edge termination 25 protrudes with respect to the primer 17 or that the primer 17 is formed with an undercut. Such an undercut with respect to the edge termination 25 of the secondary part can extend from the front edge termination 25 facing the centre of the window towards the face side 13 of the window 12 and can, by way of example, be between 0.5 mm and 1.5 mm. This ensures that a visually attractive design is produced and the primer 17 does not protrude beyond the outermost edge of the edge region 25.

In the above-mentioned exemplary embodiments according to FIG. 2, it can alternatively be provided that the primary part 52 is also bonded to the window 12 by means of a primer or bonding agent.

Furthermore, in the embodiment according to FIG. 2, it can alternatively be provided that the primary part 52 also encompasses a region on the outside 32 of the window 12 and rests thereon and/or is fixed thereto by means of primer 17 or bonding agent.

In the embodiment of the overmoulding 16 shown in FIG. 2, on the inside 31 of the window 12, the secondary part 54 is set back with respect to the edge termination of the primary part 52 facing the centre of the window. If a primer or bonding agent is applied between the primary part 52 and the window 12, this can likewise be formed with an undercut or also with a protrusion, as the protrusion on the inside is not visually disturbing, in order to achieve a complete bonding of the primary part with the inside 31 of the window 12.

According to a preferred embodiment, as shown in FIG. 2, it can be provided that the primary part 52 has a seal 34 on the inside 31 of the window 12. This seal 34 can be in the form of an elevation and, for example, be in the form of a peripheral bead or triangular hump. This seal 34 preferably extends along the edge region of the window 12 along the construction of the primary part 52. This seal 34 simultaneously serves as a delimitation for covering the primary part 52 by the secondary part 54. Such a seal 34 can simplify the sealing of the cavity in the injection moulding tool which is provided for forming the secondary part 54. This also enables the closing forces or contact forces of the mould halves of the injection moulding tool to be reduced and yet still maintain a secure seal.

Furthermore, it can alternatively be provided that the secondary part 52 is only designed to cover the outside 32 of the window 12 and only one side of the primary part 12.

In addition, the primary part 52 can be provided with fixing elements 18, such as hooks or latching elements for example, which are designed to fix the window 12 to the body or to further parts connected to the body.

FIG. 3 shows an alternative embodiment in which the secondary part 54 also completely covers the primary part 52 on the inside 31 of the window 12. In doing so, the secondary part 54 can rest on the inside 31 of the window without the use of a primer 17 or bonding agent. This is provided particularly when the primary part 52 has been moulded onto the window 12 without primer 17 or bonding agent. This arrangement can also be provided when the primary part 52 is fixed to the window 12 with primer. Alternatively, it can also be provided that this section of the secondary part 54 which rests on the inside 31 is fixed to the window 12 with a primer 17 (dashed line) in a similar way to the outside 32. Apart from this, the analogous alternative variants which have been described with regard to FIG. 2 apply to these embodiments.

As regards the 2-component overmoulding, the primary part 52 is in the form of a hard component, the dimensional stability of which is greater than that of the secondary part 54 which is in the form of a soft component. As materials for the overmoulding 16, materials which are described by way of example in EP 0 857 116 B1 are chosen for example as the hard component for the primary part 52 and as the soft component for the secondary part 54. Commercially available substances can be used as the primer. As an alternative to 2-component overmoulding, multi-component overmoulding can also be provided, with which at least one soft component grips and is fixed directly with primer 17 or bonding agent directly in the edge region 19 of the window 12 to its outer side 32.

The embodiments according to the invention have the advantage that the outside 32 can be sealed by the use of the primer 17. This enables two water tightness tests for testing the water tightness to be dispensed with during manufacture. In addition, the embodiment according to the invention has the advantage that there are no incursion points which can produce leaks, as it is also possible to mould the primary part 52 onto one side.

What is claimed is:

1. A window unit for windows in motor vehicles and the like,
comprising a window with a frame which has a frame profile and encompasses the edge of the window on at least two peripheral sides, wherein the frame grips the window or encompasses the window on at least two peripheral sides in the form of a ring which is enclosed in itself, and
the frame is formed from two profile parts having a primary part and a secondary part, and
the primary part is in the form of a hard component, the dimensional stability of which is greater than that of the secondary part which is in the form of a soft component,
wherein
the primary part is moulded onto the edge region of the window on one, two or three sides, and
the secondary part at least partially encompasses the primary part and rests directly on the window on the outside of the window and is fixed to the window by means of a primer.

2. A window unit according to claim 1, wherein the primary part extends on an inner side of the window and the secondary part at least partially encompasses the primary part on the inside of the window.

3. A window unit according to claim 2, wherein the secondary part which is arranged on the inside of the window and covers the primary part does not extend to and does not rest on the inside of the window.

4. A window unit according to claim 1, wherein the secondary part covers the primary part on the inside of the window and rests directly against the window.

5. A window unit according to claim 4, wherein the secondary part which rests on the inside of the window is at least partially fixed to the window by a primer or bonding agent.

6. A window unit according to claim 1, wherein an application width of the primer or bonding agent in the edge region of the window on its outside compared with the secondary part which covers the edge region on the outside is such that the primer or bonding agent corresponds to the width of the edge region or has an undercut with respect to the edge termination of the secondary part which projects towards the centre of the window.

7. A window unit according to claim 1, wherein an application width of the primer or bonding agent in the edge region of the window on its inside compared with the primary part which covers the edge region on the inside is such that the primer or bonding agent has an application width corresponding to the covering of the window by the primary part or a protrusion beyond the edge termination of the primary part.

8. A window unit according to claim 1, wherein in the edge region of the window, the primary part rests directly on or grips the window on the inside, on the face side or on the outside of the window or in a combination thereof, collectively or separately.

9. A window unit according to claim 1, wherein in the edge region of the window, the primary part is fixed to the window by means of primer or bonding agent on the inside, on the face side or on the outside of the window or in a combination thereof, collectively or separately.

10. A window element according to claim 1, wherein a seal, which, in order to fit the secondary part, seals a cavity in the injection moulding tool so that the secondary part does not completely encompass and cover the primary part, is formed on the primary part.

11. A window unit according to claim 10, wherein the seal is in the form of an elevation or hump which extends peripherally along the primary part in the edge region of the window.

12. A window unit according to claim 10, wherein the seal is formed on the inside of the primary part.

13. A window unit according to claim 7, wherein the protrusion and/or undercut lies in the range between 0.5 mm and 1.5 mm.
